(19) United States
(12) Patent Application Publication
(10) Pub. No.: US 2023/0326442 A1
(43) Pub. Date: Oct. 12, 2023

(54) COMPOSITE COATING MATERIAL FOR PASSIVE VIBRATION DAMPING

(71) Applicant: Agency for Science, Technology and Research, Singapore (SG)

(72) Inventors: Kui YAO, Singapore (SG); Siao Li LIEW, Singapore (SG); Shuting CHEN, Singapore (SG); Sze Yu TAN, Singapore (SG); Rogério SALLOUM, Singapore (SG); Hong YAN, Singapore (SG); Lei ZHANG, Singapore (SG); Szu Cheng LAI, Singapore (SG)

(21) Appl. No.: 18/022,975

(22) PCT Filed: Aug. 4, 2021
(86) PCT No.: PCT/SG2021/050455

§ 371 Date: Feb. 23, 2023

(30) Foreign Application Priority Data
Aug. 27, 2020 (SG) 10202008239R

(51) Int. Cl. G10K 11/165; C09D 7/61; C09D 7/40; C09D 5/24; C09D 163/00; C09D 137/00; C09D 123/08; C09D 113/00

(52) U.S. Cl. CPC G10K 11/165; C09D 7/61; C09D 7/70; C09D 5/24; C09D 163/00; C09D 137/00; C09D 123/0853; C09D 113/00; C09D 7/69

(57) ABSTRACT

A composite coating material for passive vibration damping is provided. The composite coating material includes a polymer matrix, and a piezoelectric ceramic filler and an electrically conductive filler dispersed in the polymer matrix. Particles of the piezoelectric ceramic filler have an average particle size of greater than about 100 microns (μm).

### FIELD OF THE INVENTION

The present invention relates in general to vibration damping and more particularly to a composite coating material for passive vibration damping.

### BACKGROUND OF THE INVENTION

Undesired mechanical vibrations of a structure often generate noise, cause material fatigue and even catastrophic structural failure.

There are active and passive methods of damping vibrations in mechanical structures using piezoelectric components.

In active damping methods, piezoelectric actuators are used to generate counter movements in a control loop, which effectively dampens vibrations. However, power and a complex control system are required, which limit the application ranges of active damping methods.

In passive damping methods, vibrations are converted into electrical energy through electromechanical conversion effects of a piezoelectric transducer and then dissipated as heat, for example, by means of an external shunt circuit. The shunt circuit is typically connected between electrodes of the piezoelectric transducer.

In conventional passive piezoelectric damping approaches, the piezoelectric transducer is a discrete component or pellet with electrodes and is bonded, for example, using an adhesive, on a selected location of a host structure. Implementation of such discrete piezoelectric damping components or pellets over a large area is expensive due to high costs of both the piezoelectric transducer and tedious installation and electrical connection processes. Poor conformability on a curved or uneven surface is another issue.

In view of the foregoing, it would be desirable to provide a piezoelectric material that addresses one or more of the above issues.

### SUMMARY OF THE INVENTION

Accordingly, in a first aspect, the present invention provides a composite coating material for passive vibration damping. The composite coating material includes a polymer matrix, a piezoelectric ceramic filler dispersed in the polymer matrix, and an electrically conductive filler dispersed in the polymer matrix. Particles of the piezoelectric ceramic filler have an average particle size of greater than about 100 microns (μm).

Other aspects and advantages of the invention will become apparent from the following detailed description, taken in conjunction with the accompanying drawings, illustrating by way of example the principles of the invention.

### BRIEF DESCRIPTION OF THE DRAWINGS

Embodiments of the invention will now be described, by way of example only, with reference to the accompanying drawings, in which:

FIG. 1 is a schematic diagram illustrating a composite coating material for passive vibration damping in accordance with an embodiment of the present invention on a mechanical structure;

FIG. 2 is a photograph of various composite coating materials on steel cantilevers;

FIG. 3 is a photograph of a vibration test set-up for the steel cantilevers of FIG. 2 with the various composite coating materials; and

FIG. 4 is a graph of acceleration FFT (dB) against frequency (Hz) for tested sample.

### DETAILED DESCRIPTION OF EXEMPLARY EMBODIMENTS

The detailed description set forth below in connection with the appended drawings is intended as a description of presently preferred embodiments of the invention, and is not intended to represent the only forms in which the present invention may be practiced. It is to be understood that the same or equivalent functions may be accomplished by different embodiments that are intended to be encompassed within the scope of the invention.

The term “composite” as used herein refers to being made up of two or more components.

The term “coating material” as used herein refers to a material that can be used to coat at least a portion of an underlying surface.

The term “polymer matrix” as used herein refers to a rubbery, viscoelastic and flexible material that is suitable for forming a coating on a mechanical structure with good adhesion. Examples of suitable materials for the polymer matrix include epoxy, polyvinyl butyral (PVB), acrylic rubber (for example, Silent Running SR1000 (Current, Incorporated)) and ethylene-vinyl acetate (EVA).

The term “piezoelectric ceramic” as used herein refers to an inorganic and non-metallic material that produces an electrical voltage when subjected to strain caused by vibrations, acoustical energy, compression, tension, bending, multiaxial loading and the like. Examples include, but are not limited to, potassium-sodium niobate (KNN), barium titanate (BT), and sodium bismuth titanate (BNT).

The term “filler” as used herein refers to a substance that is added to a polymer matrix, such as an elastomer, to reinforce the elastomeric network.

The term “average particle size” as used herein refers to a mean value of the particle sizes as measured, for example, by a laser diffraction particle analyser and sieves with suitable mesh sizes.

The term “electrically conductive” as used herein refers to being capable of allowing the flow of electrical charges in one or more directions.

The term “lead-free material” as used herein refers to a material that contains either no lead or less than 0.1 percent by mass (wt %).

The term “about” as used herein refers to both numbers in a range of numerals and is also used to indicate that a value includes the standard deviation of error for the device or method being employed to determine the value. The term “about” as used herein can allow for a degree of variability in a value or range, for example, within 10%, within 5%, or within 1% of a stated value or of a stated limit of a range.

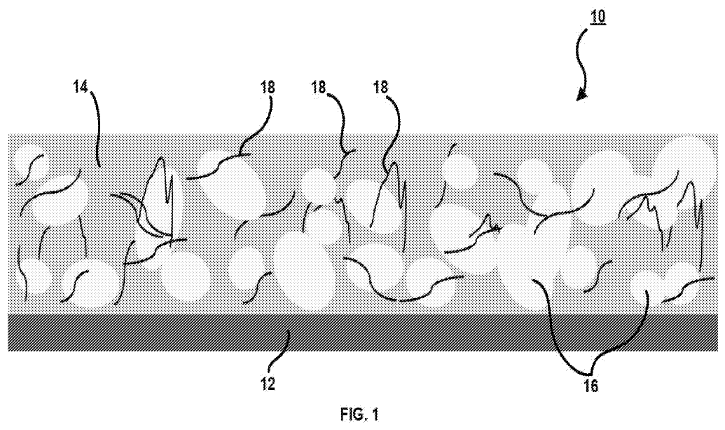

Referring now to FIG. 1, a composite coating material 10 for passive vibration damping deposited on a mechanical structure 12 is shown. The composite coating material 10 includes a polymer matrix 14, a piezoelectric ceramic filler 16 dispersed in the polymer matrix 14, and an electrically conductive filler 18 dispersed in the polymer matrix 14. Particles of the piezoelectric ceramic filler 16 have an average particle size of greater than about 100 microns (μm).

The mechanical structure 12 may be made of mild steel.

The polymer matrix 14 is viscoelastic, that is, capable of converting mechanical energy into thermal energy, and is used to form an adhesive coating on the mechanical structure 12. Viscoelastic effect by converting mechanical strain into thermal effect is utilized as another passive vibration damping mechanism in the composite coating material 10. The polymer matrix 14 may include a polymer selected from a group consisting of epoxy, polyvinyl butyral (PVB), acrylic rubber and ethylene-vinyl acetate (EVA). The composite coating material 10 may include between about 35 percent by mass (wt %) and about 79.5 wt % of the polymer matrix 14.

Through local piezoelectric effect, the piezoelectric ceramic filler 16 locally converts mechanical energy of vibrations into electrical energy that is dissipated as heat via the electrically conductive filler 18. As can be seen from FIG. 1, the composite coating material 10 deposited on the mechanical structure 12 is without any electrode. It was previously unknown and not obvious that a composite coating with piezoelectric ceramic particles dispersed in a polymer matrix, without any electrodes or electrical poling process, deposited on a mechanical structure could possess any improved passive vibration damping effect over a viscoelastic polymer matrix. Through experimental study, it was found that the composite coating material 10 with the piezoelectric ceramic particles 16 exhibits enhanced damping effect over the viscoelastic polymer matrix without any electrode or electrical poling.

The piezoelectric ceramic filler 16 may be made of a lead-free material. In one or more embodiments, the piezoelectric ceramic filler 16 may be a lead-free composition based on potassium-sodium niobate (KNN), more particularly, a potassium-sodium niobate (KNN)-based ceramic powder. Advantageously, KNN-based ceramics offer large piezoelectric coefficient.

The piezoelectric ceramic filler 16 is of specific particle sizes to enhance vibration damping performance. It was previously unknown that particle size of the ceramic powder could affect vibration damping performance. Through experimental study, it was found that the composite coating material 10 exhibited improved damping effect using specific particle sizes of the piezoelectric ceramic filler 16 in the composite coating material 10. The average particle size of the discrete ceramic particles of the piezoelectric ceramic filler 16 may be between about 400 μm and about 1000 μm.

To harness benefits of both viscoelasticity of the polymer matrix 14 and stiffness of the piezoelectric ceramic filler 16, the amount of the piezoelectric ceramic filler 16 in the polymer matrix 14 may be increased to as close as possible to an allowable maximum for forming the continuous coating. In one or more embodiments, the composite coating material 10 may include between about 20 wt % and about 60 wt % of the piezoelectric ceramic filler 16.

The electrically conductive filler 18 functions similarly to an external shunt circuit, facilitating dissipation of electrical charges into thermal energy. The electrically conductive filler 18 may include carbon nanotubes (CNT). The carbon nanotubes may be multi-walled CNTs and may have an outer diameter of between about 8 nanometres (nm) and about 15 nm and/or a length of between about 10 μm and about 30 μm. Concentration of the electrically conductive filler 18 may be varied to maintain a continuous composite coating with enhanced damping effect. In one or more embodiments, the composite coating material 10 may include between about 0.5 wt % and about 4 wt % of the electrically conductive filler 18.

A combination of the polymer matrix 14, the piezoelectric ceramic filler 16 and the electrically conductive filler 18 is used to form a continuous composite film with optimal vibration damping performance on the mechanical structure 12. Advantageously, the coating formed with the composite coating material 10 exhibits optimal passive damping performance through a combination of viscoelastic, local piezoelectric and conductive effects. The composite coating material 10 also demonstrates processing feasibility and good adhesion which are required to form the continuous coating on the mechanical structure 12.

In one embodiment, the composite coating material 10 may include about 40 wt % of the polymer matrix 14, the polymer matrix 14 being epoxy, about 58 wt % of the piezoelectric ceramic filler 16, the piezoelectric ceramic filler 16 being KNN-based ceramic, and about 2 wt % of the electrically conductive filler 18, the electrically conductive filler 18 being carbon nanotubes.

In another embodiment, the composite coating material 10 may include between about 78 wt % and about 79 wt % of the polymer matrix 14, the polymer matrix 14 being polyvinyl butyral (PVB), about 20 wt % of the piezoelectric ceramic filler 16, the piezoelectric ceramic filler 16 being KNN-based ceramic, and between about 1 wt % and about 2 wt % of the electrically conductive filler 18, the electrically conductive filler 18 being carbon nanotubes.

In yet another embodiment, the composite coating material 10 may include about 78.6 wt % of the polymer matrix 14, the polymer matrix 14 being ethylene-vinyl acetate (EVA), about 20 wt % of the piezoelectric ceramic filler 16, the piezoelectric ceramic filler 16 being KNN-based ceramic, and about 1.4 wt % of the electrically conductive filler 18, the electrically conductive filler 18 being carbon nanotubes.

In a further embodiment, the composite coating material 10 may include about 71 wt % of the polymer matrix 14, the polymer matrix 14 being acrylic rubber, about 28 wt % of the piezoelectric ceramic filler 16, the piezoelectric ceramic filler 16 being KNN-based ceramic, and about 1 wt % of the electrically conductive filler 18, the electrically conductive filler 18 being carbon nanotubes.

### Examples

Composite coatings with specific compositions formed from the composite coating material 10 will now be described in the following examples. In the examples below, “Wt. %” for each constituent component is based on the whole damping composite material comprising the polymer matrix, the lead-free piezoelectric ceramic filler and the electrically conductive filler.

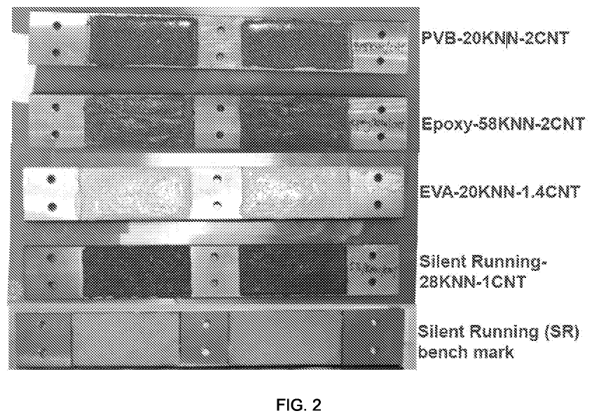

Referring now to FIG. 2, the piezoelectric composites were coated on mild steel plates as shown. Each coating was applied to two areas (50×25 mm² each) on each plate with dimensions of 175×25×5 cubic millimetres (mm³). The mass of each coating was kept constant at 7 grams (g) for all the samples in the examples for vibration damping testing.

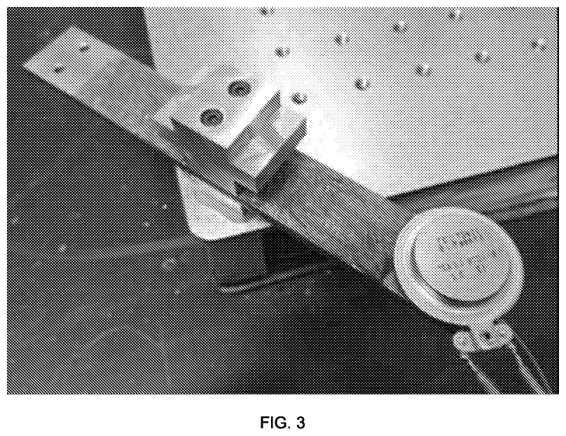

Referring now to FIG. 3, a vibration test set-up is shown. The piezoelectric composite coated mild steel plates were clamped in cantilever mode for vibration damping testing.

The vibration damping testing was performed by applying a constant excitation force to the free end of the coated cantilever plate using an actuator. An accelerometer at the free end recorded the acceleration excited by the actuator.

The mechanical properties of the vibration damping composite coatings (in cantilever mode) were characterized with Dynamic Mechanical Analyser (DMA) (Model TA Instruments DMA Q800) at 37 Hz. Dimensions of all the samples for testing were 50×10 square millimetres (mm²) with a thickness of between 1 millimetre (mm) and 2 mm.

### Example 1

Epoxy resin (SpeciFix Resin: bisphenol-A-(epichlorhydrin), average molecular weight ≤700; bisphenol-F-(epichlorhydrin), average molecular weight <700; 1,6-Hexandiol-diglycidylether) and curing agent (SpeciFix-40: 3-Aminomethyl-3,5,5-trimethylcyclohexylamine; benzyl alcohol) (in mass ratio 100:25) were used to prepare the epoxy polymer matrix. Amount of KNN-based lead-free piezoelectric ceramic powder was fixed at approximately 58 wt. % and that of CNT varied in the range of 1 to 4 wt. %. The KNN-based ceramic powder had a composition of (K_{0.44}Na_{0.52}Li_{0.34})(Nb_{0.84}Ta_{0.10}Sb_{0.36})O₃.

For fabricating the KNN-based ceramic powder, starting powders of K₂CO₃, Na₂CO₃, Li₂CO₃, Nb₂O₅, Ta₂O₅ and Sb₂O₅ according to stoichiometric ratio were mixed with ethanol by ball milling process. The slurry obtained was then dried in an oven at 130° C. and crushed thereafter to remove particle agglomerations. The powdery mixture was first synthesized in a furnace at 850° C. for 5 hours followed by calcination at 1000° C. for different durations up to 5 hours to enhance the crystallinity and improve the particle size. The calcined KNN-based powder was crushed and sieved through meshes of different sizes to obtain varied particle sizes. Two kinds of KNN powder were obtained with average particle size of between about 100 μm and about 180 μm, and between 400 μm and 1000 μm.

For preparing a composite coating for passive damping on a mechanical structure, the epoxy resin, the KNN-based powder and the CNT powder were mechanically mixed thoroughly first at room temperature, then the curing agent was added and mixed. The mixture was then poured onto a mechanical structure, such as a mild steel or Teflon structure, and cured at an elevated temperature, such as at 70° C., to form the composite coating with passive damping function on the mechanical structure. The composite material is referred as Epoxy-KNN-CNT.

For DMA testing, the composite coatings were prepared in Teflon moulds and cured at 70° C. For vibration testing, the same composite coatings were applied to mild steel plates and cured at the same condition. For comparison, a commercial damping material Silent Running SR1000 (SR) was used to benchmark the performance. SR is an acrylic-based coating with proven passive vibration damping effect. For DMA and vibration testing, SR was applied to Teflon mould and mild steel plate, respectively, and cured under ambient conditions overnight. DMA measurement results for the Epoxy-KNN-CNT coatings in comparison with the benchmark are shown in Table 1 below.

TABLE 1

| | Storage | Loss | |
|---|---|---|---|
| | modulus | modulus | Tan |
| Composite Coating | (MPa) | (MPa) | delta |
| Epoxy-KNN-CNT (1 wt. % CNT) | 415.07 | 284.72 | 0.69 |
| Epoxy-KNN-CNT (2 wt. % CNT) | 598.00 | 335.70 | 0.56 |
| Epoxy-KNN-CNT (3 wt. % CNT) | 363.16 | 208.67 | 0.57 |
| Epoxy-KNN-CNT (4 wt. % CNT) | 408.73 | 237.26 | 0.58 |
| Epoxy-KNN-CNT (large | 783.72 | 408.15 | 0.52 |
| KNN particles, 2 wt. % CNT) | | | |
| Silent Running SR1000 | 192.30 | 180.40 | 0.94 |

The DMA results in Table 1 show that the wt. % of CNT significantly affects the mechanical properties and damping performance. The storage modulus indicates the ability of a material to store energy and the loss modulus indicates the ability to dissipate energy arising from stress during mechanical vibration. Tan delta is the ratio of loss modulus to storage modulus. Table 1 shows that the Epoxy-KNN-CNT composites have much higher loss modulus values than the SR coating, particularly for the composite with 2 wt. % CNT. It is noted in Table 1 that the Epoxy-KNN-CNT composites with larger particle size of KNN-based piezoelectric ceramic exhibit significantly further improved loss modulus.

Vibration damping data for mild steel plates with the Epoxy-KNN-CNT coatings in comparison with the benchmark is shown in Table 2 below.

TABLE 2

| | Resonance | | Damping |
|---|---|---|---|
| | frequency | Reduction | ratio |
| Composite Coating | (Hz) | (dB) | (%) |
| Epoxy-KNN-CNT (2 wt. % CNT) | 479.3 | −1.69 | 4.6 |
| Epoxy-KNN-CNT (larger | 492.8 | −1.93 | 5.0 |
| KNNLST particles, 2 wt. % CNT) | | | |
| Silent Running SR1000 | 484.7 | −0.13 | 4.0 |
| Mild Steel without coating | 476.8 | 0 | 4.0 |

The vibration damping results in Table 2 show that the mild steel plates with Epoxy-KNN-CNT composite coatings have higher reduction (dB) and damping ratios than that with the Silent Running coating, particularly for the composite coating with the larger KNN particles.

### Example 2

Polyvinyl butyral (PVB) (Tape Casting Warehouse, B-98) and plasticizer (Tape Casting Warehouse Santicizer 160, butyl benzyl phthalate) (in mass ratio 100:30) were used to prepare the polymer matrix. The KNN-based ceramic powder was prepared according to the same method as described in Example 1.

For preparing PVB-KNN-CNT composite in this embodiment, the PVB, plasticizer, KNN-based ceramic powder and CNT powder were thoroughly mixed at room temperature. KNN-based ceramic was fixed at 20 wt. % and that of CNT powder in the range of 1 to 4 wt. %. The mixture was heated and melted at 160° C. in a container, and the melt was poured over a mechanical structure, such as a Teflon or mild steel plate, to form a vibration damping composite coating. For DMA and vibration testing, the PVB-KNN-CNT composite coating was formed in Teflon mould and mild steel plate, respectively.

DMA measurement results for PVB-KNN-CNT in comparison with the benchmark (37 Hz) are shown in Table 3 below.

TABLE 3

| | Storage | Loss | |
|---|---|---|---|
| | modulus | modulus | Tan |
| Composite Coating | (MPa) | (MPa) | delta |
| PVB-KNN-CNT (1 wt. % CNT) | 863.15 | 238.19 | 0.28 |
| PVB-KNN-CNT (2 wt. % CNT) | 842.06 | 207.08 | 0.25 |
| PVB-KNN-CNT (3 wt. % CNT) | 513.39 | 139.82 | 0.27 |
| PVB-KNN-CNT (4 wt. % CNT) | 481.83 | 136.09 | 0.28 |
| Silent Running SR1000 | 192.30 | 180.40 | 0.94 |

The DMA results in Table 3 show that the PVB-KNN-CNT composite coatings with 1 and 2 wt. % CNT have higher loss modulus than the Silent Running coating.

Vibration damping data of the mild steel plates with the PVB-KNN-CNT coatings in comparison with the benchmark is shown in Table 4 below.

TABLE 4

| | Resonance | | Damping |
|---|---|---|---|
| | frequency | Reduction | ratio |
| Composite Coating | (Hz) | (dB) | (%) |
| PVB-KNN-CNT (1 wt. % CNT) | 479.7 | −0.95 | 4.5 |
| PVB-KNN-CNT (2 wt. % CNT) | 491.8 | −3.05 | 5.7 |
| Silent Running SR1000 | 484.7 | −0.13 | 4.0 |
| Mild Steel | 476.8 | 0 | 4.0 |

The vibration damping testing results in Table 4 show higher vibration reduction (dB) and damping ratios for the plates with the PVB-KNN-CNT composites than the Silent Running coating.

### Example 3

Ethylene-vinyl acetate (EVA) was used as the polymer matrix. The KNN-based ceramic powder was prepared according to the same method as described in Example 1.

For preparing EVA-KNN-CNT composite in this embodiment, the EVA, KNN-based ceramic powder and CNT powder were mixed at room temperature. The amount of KNN powder was 20 wt. % and that of CNT powder 1.4 wt. %. The mixture was brush coated onto a mechanical structure, such as a mild steel plate, and cured at room temperature or elevated temperature at 60° C. to form a vibration damping coating. For vibration damping testing, the EVA-KNN-CNT composite coating was prepared on a mild steel plate.

Vibration damping testing data of a mild steel plate with the EVA-KNN-CNT composite coating in comparison with the benchmark is shown in Table 5 below.

TABLE 5

| | Resonance | | Damping |
|---|---|---|---|
| | frequency | Reduction | ratio |
| Composite Coating | (Hz) | (dB) | (%) |
| EVA-KNN-CNT (1.4 wt. % CNT) | 494.0 | — | 5.2 |
| Silent Running SR1000 | 484.7 | −0.13 | 4.0 |
| Mild Steel | 476.8 | 0 | 4.0 |

The vibration damping results in Table 5 of the mild steel plate with the EVA-KNN-CNT composite coating show higher damping ratio than that with the Silent Running coating.

### Example 4

Silent Running SR1000 (Current, Incorporated) was used as the polymer matrix in this example. The KNN-based lead-free piezoelectric ceramic powder with a composition of (K_{0.47}Na_{0.47}Li_{0.06})NbO₃ was fabricated according to the method as described in Example 1, except that the starting powders were K₂CO₃, Na₂CO₃, Li₂CO₃ and Nb₂O₅.

For preparing SR-KNN-CNT composite in this embodiment, the Silent Running SR1000, KNN-based ceramic powder and CNT powder were mixed at room temperature. The amount of KNN-based powder was 28 wt. % and that of CNT powder was in the range of 0.5 to 1 wt. %. The mixture was coated on a mechanical structure, such as a mild steel plate, and cured at room temperature to form a vibration damping coating.

Vibration damping testing data of a mild steel plate with the SR-KNN-CNT composite coating in comparison with the benchmark is shown in Table 6 below.

TABLE 6

| | Resonance | | Damping |
|---|---|---|---|
| | frequency | Reduction | ratio |
| Composite Coating | (Hz) | (dB) | (%) |
| SR-KNN-CNT (1 wt. % CNT) | 430.0 | — | 4.6 |
| Silent Running SR1000 | 484.7 | −0.13 | 4.0 |
| Mild Steel | 476.8 | 0 | 4.0 |

The vibration damping results in Table 6 of the mild steel plate with the SR-KNN-CNT composite coating show higher damping ratio than that with the Silent Running coating.

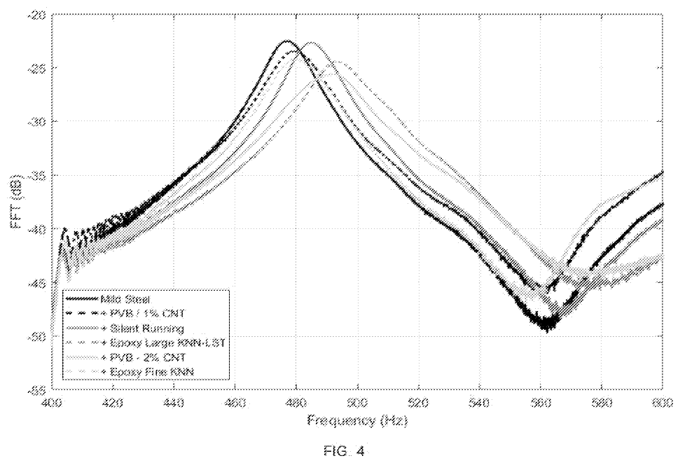

Referring now to FIG. 4, a graph of acceleration FFT (dB) against frequency (Hz) as measured with the vibration structure coated with the composite coatings is shown. From the peak measured around the resonance frequency, the damping ratio values of the tested structure with various coatings can be obtained and compared. The reduced acceleration peaks indicate that all of the piezoelectric composite coatings show higher damping ratios than the mild steel without any coating and the one coated with Silent Running as benchmark.

As is evident from the foregoing discussion, advantages of composite coatings formed with the composite coating material of the present invention include the use of passive vibration damping versus an active approach. Consequently, no power consumption and no external control or signal processing are required. Further, because only a damping material is used, no electrode, no electrical connection and no electric load are required. The lead-free piezoelectric damping coating is scalable for large area implementation and of an environmentally friendly composition. Further advantageously, the piezoelectric damping composite coating achieves enhanced damping performance with additional piezoelectric effect (or at least local piezoelectric effect) over viscoelastic effect (directly converting mechanical strain into thermal effect).

The composite coating material of the present invention may be applied as a coating in respect of vibration and noise mitigation for machinery industry equipment, aircraft, trains, automobiles, ships and railway tracks.

While preferred embodiments of the invention have been described, it will be clear that the invention is not limited to the described embodiments only. Numerous modifications, changes, variations, substitutions and equivalents will be apparent to those skilled in the art without departing from the scope of the invention as described in the claims.

Further, unless the context clearly requires otherwise, throughout the description and the claims, the words “comprise”, “comprising” and the like are to be construed in an inclusive as opposed to an exclusive or exhaustive sense; that is to say, in the sense of “including, but not limited to”.

1. A composite coating material for passive vibration damping, comprising:
a polymer matrix;
a piezoelectric ceramic filler dispersed in the polymer matrix, wherein particles of the piezoelectric ceramic filler have an average particle size of greater than about 100 microns (μm); and
an electrically conductive filler dispersed in the polymer matrix.

2. The composite coating material according to claim 1, wherein the average particle size of the particles of the piezoelectric ceramic filler is between about 400 μm and about 1000 μm.

3. The composite coating material according to claim 1, further comprising between about 20 percent by mass (wt %) and about 60 wt % of the piezoelectric ceramic filler.

4. The composite coating material according to claim 1, wherein the piezoelectric ceramic filler comprises a lead-free material.

5. The composite coating material according to claim 4, wherein the piezoelectric ceramic filler comprises a potassium-sodium niobate (KNN)-based ceramic powder.

6. The composite coating material according to claim 1, further comprising between about 35 wt % and about 79.5 wt % of the polymer matrix.

7. The composite coating material according to claim 1, wherein the polymer matrix comprises a polymer selected from a group consisting of epoxy, polyvinyl butyral (PVB), acrylic rubber and ethylene-vinyl acetate (EVA).

8. The composite coating material according to claim 1, further comprising between about 0.5 wt % and about 4 wt % of the electrically conductive filler.

9. The composite coating material according to claim 1, wherein the electrically conductive filler comprises carbon nanotubes.

10. The composite coating material according to claim 9, wherein the carbon nanotubes have an outer diameter of between about 8 nanometres (nm) and about 15 nm.

11. The composite coating material according to claim 9, wherein the carbon nanotubes have a length of between about 10 μm and about 30 μm.

12. The composite coating material according to claim 1, comprising:
about 40 wt % of the polymer matrix, wherein the polymer matrix comprises epoxy;
about 58 wt % of the piezoelectric ceramic filler, wherein the piezoelectric ceramic filler comprises KNN-based ceramic; and
about 2 wt % of the electrically conductive filler, wherein the electrically conductive filler comprises carbon nanotubes.

13. The composite coating material according to claim 1, comprising:
between about 78 wt % and about 79 wt % of the polymer matrix, wherein the polymer matrix comprises polyvinyl butyral (PVB);
about 20 wt % of the piezoelectric ceramic filler, wherein the piezoelectric ceramic filler comprises KNN-based ceramic; and
between about 1 wt % and about 2 wt % of the electrically conductive filler, wherein the electrically conductive filler comprises carbon nanotubes.

14. The composite coating material according to claim 1, comprising:
about 78.6 wt % of the polymer matrix, wherein the polymer matrix comprises ethylene-vinyl acetate (EVA);
about 20 wt % of the piezoelectric ceramic filler, wherein the piezoelectric ceramic filler comprises KNN-based ceramic; and
about 1.4 wt % of the electrically conductive filler, wherein the electrically conductive filler comprises carbon nanotubes.

15. The composite coating material according to claim 1, comprising:
about 71 wt % of the polymer matrix, wherein the polymer matrix comprises acrylic rubber;
about 28 wt % of the piezoelectric ceramic filler, wherein the piezoelectric ceramic filler comprises KNN-based ceramic; and
about 1 wt % of the electrically conductive filler, wherein the electrically conductive filler comprises carbon nanotubes.
